(19) United States
(12) Patent Application Publication
(10) Pub. No.: US 2020/0106124 A1
(43) Pub. Date: Apr. 2, 2020

(54) Anode Active Materials for Lithium-ion Batteries

(71) Applicant: Hong Kong Applied Science and Technology Research Institute Company Limited, Hong Kong (CN)

(72) Inventors: Senlin WANG, Hong Kong (CN); Laiyong XIE, Shenzhen (CN); Jing XIANG, Hong Kong (CN); Weiqun LI, Hong Kong (CN)

(21) Appl. No.: 16/145,267

(22) Filed: Sep. 28, 2018

(51) Int. Cl. H01M 10/0525; H01M 4/134; C01B 32/184; H01M 4/133; H01M 4/583; H01M 4/38; H01M 4/36

(52) U.S. Cl. CPC H01M 10/0525; H01M 4/134; C01B 32/184; H01M 2004/027; H01M 4/583; H01M 4/386; H01M 4/362; H01M 4/133

(57) ABSTRACT

Provided herein are silicon-based anode active materials for use in lithium-ion batteries, to their method of preparation and to their use in the anode of a lithium-ion battery. Also disclosed herein are lithium-ion batteries and anodes manufactured using the anode active materials described herein.

### FIELD OF THE INVENTION

The subject matter disclosed herein generally relates to the field of energy storage. More particularly, the subject matter disclosed herein relates to anode active materials for use in lithium-ion batteries, to their method of preparation and to their use in the anode of a lithium-ion battery. Also disclosed herein are lithium-ion batteries and anodes manufactured using the anode active materials described herein.

### BACKGROUND OF THE INVENTION

Silicon is one of the most promising anode materials for lithium-ion batteries, because it has the highest known theoretical capacity (˜3,800 mAh/g), it is highly abundant in nature and can be mined and refined in an environmentally friendly fashion. However, significant barriers to the realization of high capacity silicon based anode active materials exist. For example, silicon experiences a substantial volume change during the insertion and deinsertion of lithium ions during the continuous charge-discharge processes, which can cause significant structural degradation to the anode that can result in a loss of specific capacity and increased battery impedance. Such drawbacks may further result in potential safety issues of the lithium-ion batteries.

A number of silicon anode materials for lithium-ion batteries have been developed to address silicon volume change during the charge-discharge process. It has been found that when silicon particles below a critical size of 150 nm in diameter are used in anode active materials that the silicon particles experience lower levels of cracking and fracture during lithiation/delithiation. However, manufacturing silicon particles having a diameter below 150 nm is very costly and consequently is not commercially feasible. Alternative approaches involve creating shells around the silicon particles, which act to mechanically limit the volume change silicon experiences during lithiation/delithiation. However, these anode active materials typically require complicated and costly processes for preparing the silicon core shell structures.

In view of the foregoing, there is a need to develop new silicon based anode active materials that can be prepared in a straight forward and economic fashion and also exhibit high capacity retention after repeated charge/discharge cycles.

### SUMMARY OF THE INVENTION

To at least partially address the aforementioned issues, the present disclosure provides silicon-based anode active materials, which can be prepared in a straight forward and economic fashion. The anode active materials include void spaces within a composite comprising a silicon based material, a carbon based material, and carbonaceous material. The anode active materials disclosed herein can exhibit many advantageous properties. For example, lithium ions can easily diffuse in and through the anode active material due, in part, to its porous structure and void spaces present in the anode active material can at least partially suppress the swelling of the silicon based material during electrochemical reaction, such that the structural degradation of the anode material can be at least partially alleviated.

In a first aspect, provided herein is a method for preparing an anode active material comprising the steps of:
a) contacting a silicon based material with a dispersant thereby forming a first mixture comprising the silicon based material and the dispersant;
b) contacting the first mixture with a carbon based material thereby forming a second mixture comprising the silicon based material, the carbon based material, and the dispersant; and
c) subjecting the second mixture to heat treatment thereby forming the anode active material,
   wherein the particle size of the silicon based material is 100 to 300 nm and the particle size of the carbon based material is 10 to 30 μm.

In a first embodiment of the first aspect, provided herein is the method of the first aspect, wherein the silicon based material is selected from the group consisting of silicon particles, SiOₓ particles, SiO particles, and combinations thereof, wherein x is 0.1 to 1.9.

In a second embodiment of the first aspect, provided herein is the method of the first aspect, wherein the carbon based material is selected from the group consisting of graphite particles, carbon black particles, and combinations thereof.

In a third embodiment of the first aspect, provided herein is the method of the first aspect, wherein the dispersant is at least one compound selected from the group consisting of glucose, fructose, sucrose, cellulose, starch, citric acid, carboxymethyl cellulose, polyacrylic acid, polymethylacrylate, polyether imide, polyvinyl pyrrolidone, epoxy resin, phenolic resin and pitch.

In a fourth embodiment of the first aspect, provided herein is the method of the first aspect, wherein the mass ratio of the silicon based material to the dispersant to the carbon based material in the second mixture is 0.5:7:20 to 3:7:20.

In a fifth embodiment of the first aspect, provided herein is the method of the first aspect further comprising the steps of ball milling the first mixture prior to the step of contacting the first mixture with the carbon based material; and ball milling the second mixture prior to the step of subjecting the second mixture to heat treatment.

In a sixth embodiment of the first aspect, provided herein is the method of the fifth embodiment of the first aspect further comprising the step drying the second mixture after the step of ball milling the second mixture and before the step of subjecting the second mixture to heat treatment.

In a seventh embodiment of the first aspect, provided herein is the method of the first aspect, wherein the step of heat treatment comprises heating the second mixture at a temperature of 300 to 1,000° C. under an inert atmosphere.

In an eighth embodiment of the first aspect, provided herein is the method of the fifth embodiment of the first aspect, wherein the particle size of the anode active material is 8 to 25 μm.

In a second aspect, provided herein is a method for preparing an anode active material comprising the steps of:
a) contacting silicon particles having a particle size of 10-30 μm, with glucose thereby forming a first mixture comprising the silicon particles and glucose having a mass ratio of 0.5:7 to 3:7;
b) ball milling the first mixture thereby forming a milled first mixture comprising silicon particles having a D50 of 150 to 190 nm;
c) contacting the first mixture with graphite particles having a D50 of 15 to 16 μm thereby forming a second mixture comprising the silicon particles, the graphite particles, and glucose having a mass ratio of the silicon particles to the graphite particles to glucose of 0.5:20:7to 3:20:7;
d) ball milling the second mixture thereby forming a milled second mixture;
e) drying the milled second mixture thereby forming a dried second mixture; and
f) subjecting the dried second mixture to heat treatment at 700 to 900° C. under an inert atmosphere thereby forming the anode active material,
   wherein the D50 of the anode active material is 11.5 to 12.5 μm and the anode active material has a Brunauer-Emmett-Teller (BET) surface area of 3.05-3.15 m²/g.

In a third aspect, provided herein is an anode active material prepared according to the method of the first aspect.

In a fourth aspect, provided herein is an anode active material prepared according to the method of the second aspect.

In a fifth aspect, provided herein is an anode comprising the anode active material of the third aspect.

In a sixth aspect, provided herein is an anode comprising the anode active material of the fourth aspect.

In a seventh aspect, provided herein is a lithium-ion battery comprising the anode of the fifth aspect.

In an eighth aspect, provided herein is a lithium-ion battery comprising the anode of the sixth aspect.

In a first embodiment of the seventh aspect, provided herein is the lithium-ion battery of the seventh aspect, wherein the anode active material has a specific capacity between 400 to 500 mAh/g.

In a second embodiment of the seventh aspect, provided herein is the lithium-ion battery of the seventh aspect, wherein the anode active material has a capacity retention of between 75% and 95% after 400 cycles.

In a first embodiment of the eighth aspect, provided herein is the lithium-ion battery of the eighth aspect, wherein the anode active material has a specific capacity between 400 to 450 mAh/g.

In a second embodiment of the eighth aspect, provided herein is the lithium-ion battery of the eighth aspect, wherein the anode active material has a capacity retention of between 85% and 90% after 400 cycles.

### BRIEF DESCRIPTION OF THE DRAWINGS

The above and other objects and features of the present disclosure will become apparent from the following description of the invention, when taken in conjunction with the following drawings.

FIG. 1A depicts a scanning electron microscopy (SEM) image of silicon nanoparticles prepared by ball milling micro Si particles having an average size of 50 μm. The obtained Si particles shown in FIG. 1A having an average particle size of about 200 nm at a magnification of 10,000 (legend: 5 μm) according to certain embodiments of the present disclosure.

FIG. 1B depicts a SEM image of silicon nanoparticles having an average particle size of about 200 nm at a magnification of 25,000 (legend: 2 μm) according to certain embodiments of the present disclosure.

FIG. 1C depicts a SEM image of graphite nanoparticles, prior to ball milling, having an average particle size of about 10 to 15 μm at a magnification of 1,000 (legend: 50 μm) according to certain embodiments of the present disclosure.

FIG. 1D depicts a SEM image of graphite nanoparticles, prior to ball milling, having an average particle size of about 10 to 15 μm at a magnification of 2500 (legend: 20 μm) according to certain embodiments of the present disclosure.

FIG. 1E depicts a SEM image of anode active material having an average particle size of about 10 to 15 μm at a magnification of 1,000 (legend: 50 μm) according to certain embodiments of the present disclosure.

FIG. 1F depicts a SEM image of anode active material having an average particle size of about 10 to 15 μm at a magnification of 2500 (legend: 20 μm) according to certain embodiments of the present disclosure.

FIG. 1G depicts an energy-dispersive spectroscopy (EDS) image of anode active material having an average particle size of about 10 to 15 μm according to certain embodiments of the present disclosure.

FIG. 1H depicts an EDS element mapping image of carbon in the anode active material according to certain embodiments of the present disclosure indicating the distribution of carbon in the anode active material in the lighter color.

FIG. 1I depicts an EDS element mapping image of silicon in the anode active material according to certain embodiments of the present disclosure indicating the distribution of silicon in the anode active material in the lighter color.

FIG. 2 depicts a SEM image of an anode active material according to certain embodiments of the present disclosure.

FIG. 3 depicts a plot of specific capacity and initial columbic efficiency versus cycle number for a battery made using the Sample 1 anode active material according to certain embodiments of the present disclosure.

FIG. 4 depicts a plot of specific capacity and initial columbic efficiency versus cycle number for a battery made using the Sample 2 anode active material according to certain embodiments of the present disclosure.

FIG. 5 depicts a plot of specific capacity and initial columbic efficiency versus cycle number for a battery made using the Sample 3 anode active material comprising silicon and graphite and not containing a dispersant.

FIG. 6 depicts a plot of specific capacity versus cycle number for a battery made using the Sample 4 anode active material comprising silicon.

FIG. 7 depicts a plot of specific capacity versus cycle number for a battery made using the Sample 5 anode active material comprising silicon and graphite.

FIG. 8 depicts a particle size distribution graph of silicon particles after ball milling (of the same silicon particles shown in FIGS. 1A and 1B) used in connection with the preparation of certain embodiments of the anode active materials of the present disclosure.

FIG. 9 depicts a particle size distribution graph of graphite particles, prior to ball milling, (of the same graphite particles shown in FIGS. 1C and 1D) used in connection with the preparation of certain embodiments of the anode active materials of the present disclosure.

FIG. 10 depicts a particle size distribution graph of the as prepared silicon anode active materials (of the same silicon anode active materials shown in FIGS. 1E and 1F) in accordance with certain embodiments of the present disclosure.

FIG. 11A depicts the X-ray powder diffraction (XRD) pattern of silicon particles used in connection with the preparation of certain embodiments of the anode active materials of the present disclosure.

FIG. 11B depicts the XRD pattern of graphite particles used in connection with the preparation of certain embodiments of the anode active materials of the present disclosure.

FIG. 11C depicts the XRD pattern of the as prepared silicon anode active materials in accordance with certain embodiments of the present disclosure.

FIG. 12 depicts a plot of volume vs relative pressure for silicon particles, graphite and anode active material comprising silicon particles, graphite, and a dispersant in accordance with certain embodiments of the present disclosure.

FIG. 13 depicts a plot of the pore size distribution curves for silicon particles, graphite and anode active material comprising silicon particles, graphite, and a dispersant in accordance with certain embodiments of the present disclosure.

FIG. 14 depicts a plot of specific capacity and initial columbic efficiency versus cycle number for a battery made using the Sample 6 anode active material comprising nano-sized Si, CMC derived carbonaceous material, and graphite.

FIG. 15 depicts a plot of specific capacity and initial columbic efficiency versus cycle number for a battery made using the Sample 7 anode active material comprising nano-sized Si, glucose derived carbonaceous material, and graphite.

FIG. 16 depicts a plot of specific capacity and initial columbic efficiency versus cycle number for a battery made using the Sample 8 anode active material comprising nano-sized Si, PVP and CMC derived carbonaceous material, and graphite.

FIG. 17 depicts a plot of specific capacity and initial columbic efficiency versus cycle number for a battery made using the Sample 9 anode active material comprising nano-sized Si, CMC and glucose derived carbonaceous material, and graphite.

FIG. 18 depicts a plot of specific capacity and initial columbic efficiency versus cycle number for a battery made using the Sample 10 anode active material comprising nano-sized Si, PVP and glucose derived carbonaceous material, and graphite.

FIG. 19 depicts a plot of specific capacity and initial columbic efficiency versus cycle number for a battery made using the Sample 11 anode active material comprising nano-sized SiO, glucose derived carbonaceous material, and graphite.

FIG. 20 depicts a plot of specific capacity versus and initial columbic efficiency cycle number for a battery made using the Sample 12 anode active material comprising nano-sized SiO_{0.8}, glucose derived carbonaceous material, and graphite.

### DETAILED DESCRIPTION OF THE INVENTION

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

As used herein, the particle size refers to the largest dimension of the particle.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. Moreover, two or more steps or actions may be conducted simultaneously.

The present disclosure relates to methods for preparing silicon based anode active materials having improved capacity retention and excellent coulombic efficiency (near 100%) and products thereof. The anode active materials can comprise silicon based materials, carbon based materials, and carbonaceous material formed from heat treatment of a dispersant as described herein. The anode active materials described herein can be used in the preparation of anodes for secondary batteries.

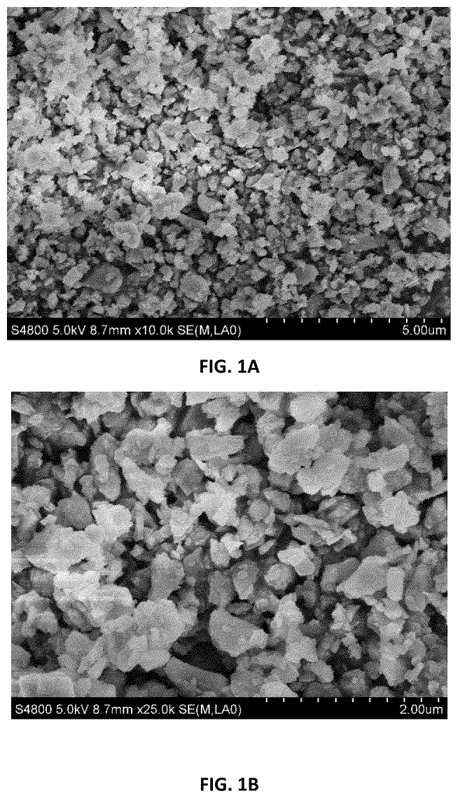

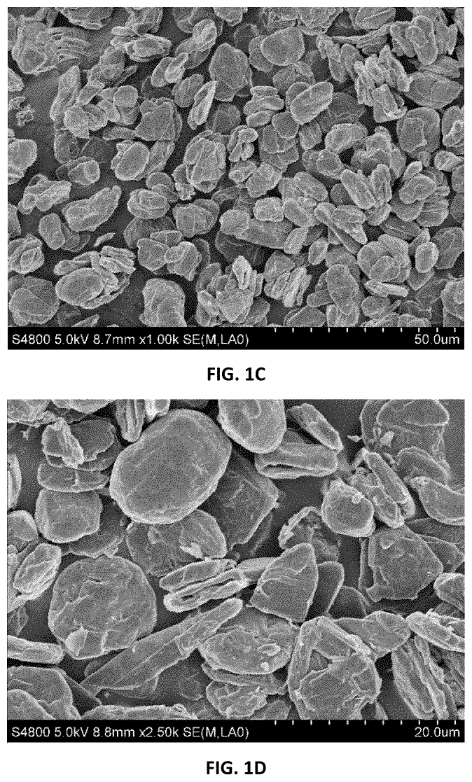

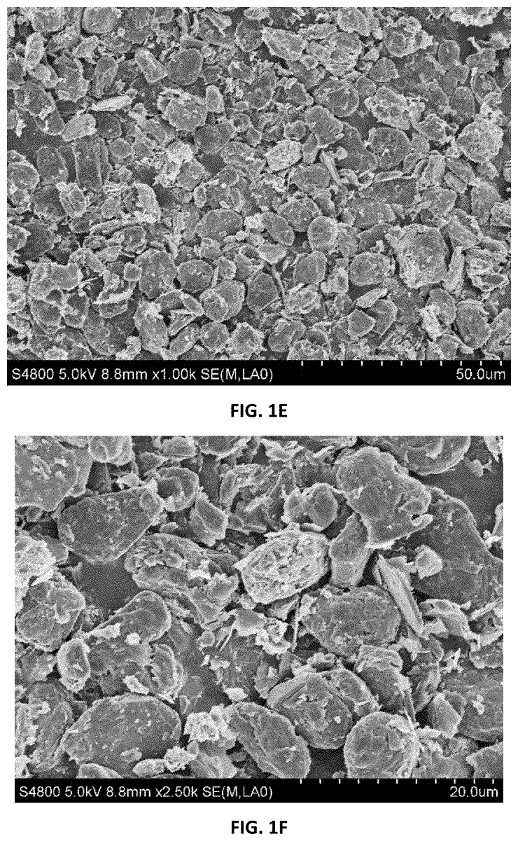

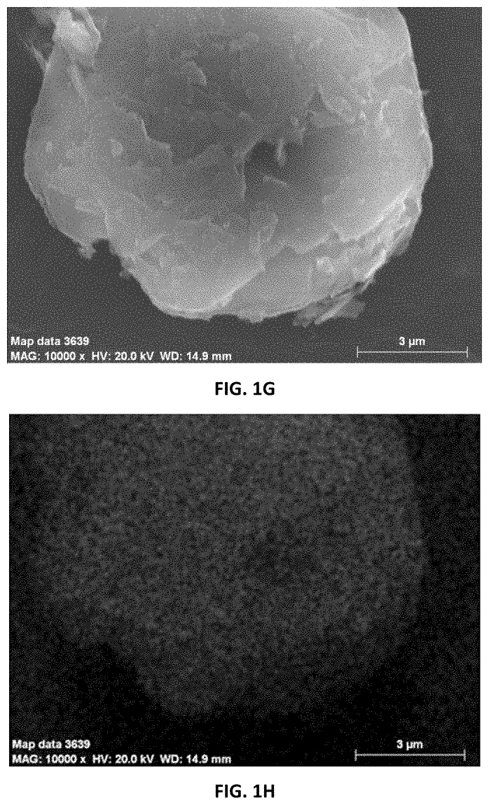

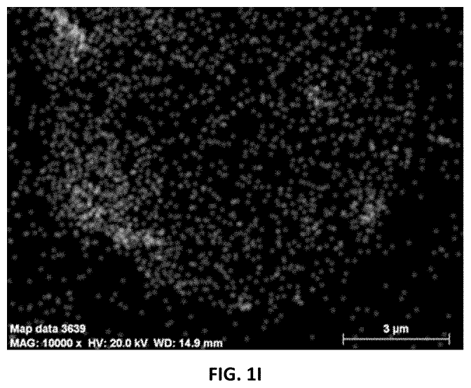

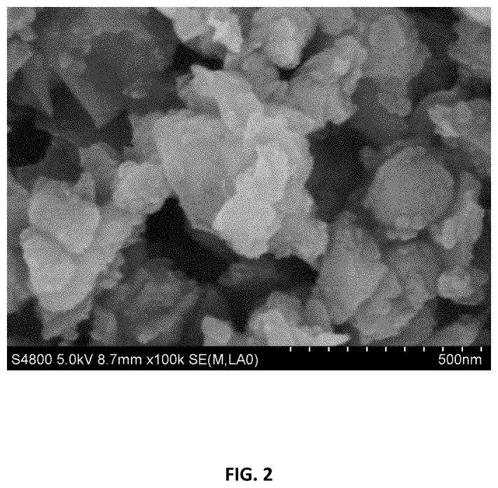

As demonstrated by the SEM images depicted in FIGS. 1E, 1F, 1G, 1H, 1I, and 2 the anode active materials can be highly heterogeneous in structure and can present a large surface area and a large amount of void space and/or pores within the anode active materials. These void spaces and/or pores can provide enclosed volumes of space that can at least partially constrain the extent that the silicon based material expands during lithiation/delithiation cycles thereby inhibiting structural damage to the anode active material and improving capacity retention after repeated cycling. Advantageously, the anode active materials described herein require no complicated methodologies to prepare core-shell structures typically employed to inhibit silicon swelling during lithiation/delithiation cycles. Instead, the swelling of the silicon can be inhibited by the surfaces of the carbon based material surrounding void spaces/pores in proximity to the silicon based material.

Carbon based materials suitable for use in the methods disclosed herein include, but are not limited to natural graphite, artificial graphite, mesocarbon micro-bead (MCMB), graphitic coke, mesoporous carbon, hard carbon, soft carbon (e.g., carbon black), amorphous carbon, carbon or graphite fiber segments, carbon nanofiber or graphitic nanofiber, carbon nanotubes, graphene, graphene oxide or a combination thereof.

The carbon based material can have an average particle size of 10 to 30 μm. In certain embodiments, the average particle size is 10 to 28; 10 to 26; 10 to 24; 10 to 22; 10 to 20; 12 to 20; 14 to 20; 14 to 18; 16 to 18; 16 to 17; or 15 to 16 μm. In certain embodiments, the carbon based material has a D50 particle size of 12 to 18; 12 to 16; 14 to 16; or 15 to 16 μm. FIG. 9 depicts the particle size distribution of exemplary graphite particles.

Silicon based materials useful in the methods for preparing the anode active materials provided herein, include but are not limited to elemental silicon particles, SiOₓ particles, silicon oxide (SiO) particles, wherein x is 0.1 to 1.9, or a combination thereof. In certain embodiments, x is 0.7-1.0; 0.7-0.9; or 0.75 to 0.85. The silicon based material can be amorphous, crystalline, or a combination thereof.

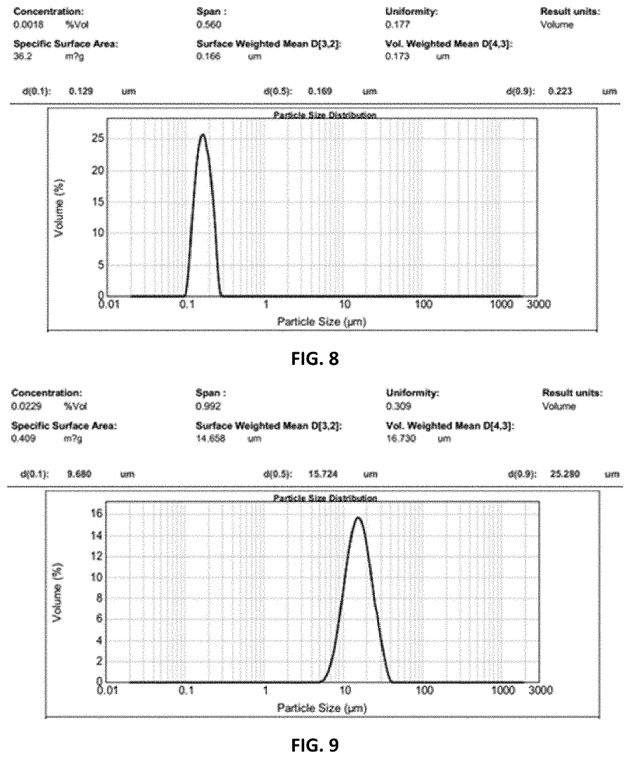

The silicon based material can have an average particle size of 100 to 300 nm. In certain embodiments, the average particle size is 120 to 280; 120 to 260; 120 to 240; 120 to 220; 120 to 200; 140 to 200; 140 to 180; 160 to 180; or 170 to 180 nm. In certain embodiments, the silicon based material has a D50 particle size of 120 to 280; 120 to 260; 120 to 240; 120 to 220; 120 to 200; 140 to 200; 140 to 180; 150 to 190; 160 to 180; or 165 to 175 nm. FIG. 8 depicts the particle size distribution of exemplary silicon particles after ball milling.

As can be demonstrated by the EDS element mapping image of silicon in the anode active material depicted in FIG. 1I, the silicon based material is substantially evenly distributed in anode active material.

Exemplary dispersants useful in the preparation of the anode active materials described herein include, but are not limited to, glucose, fructose, sucrose, cellulose, starch, citric acid, carboxymethyl cellulose (CMC), sodium carboxymethyl cellulose, cetyl trimethylammonium bromide, sodium dodecyl sulfate, polyacrylic acid, polymethylacrylate, polyether imide, polyvinyl pyrrolidone (PVP), epoxy resin, phenolic resin, pitch, and combinations thereof. In certain embodiments, the dispersant comprises a material selected from the group consisting of PVP, CMC, and glucose, and combinations thereof. In certain embodiments, the dispersant is glucose, glucose and CMC, glucose and PVP, CMC and PVP, or PVP. In certain embodiments the dispersant comprises glucose, glucose and CMC, or glucose and PVP.

The silicon based material can be mixed with the dispersant in the presence of a solvent or neat. In instances where a solvent is used, any solvent can be used. Exemplary solvents include, water, alcohols, ethers, esters, ketones, hydrocarbons, aromatics, haloalkanes, and combinations thereof. In certain embodiments, the solvent is water, ethanol, isopropanol, or a combination thereof.

Silicon based material having a particle size of 100 to 300 nm is available commercially or can be prepared from silicon based material having a particle size larger than 300 nm.

There are various known methods for controlling the particle size of substances, including reduction by comminution or de-agglomeration by milling and/or sieving. Exemplary methods for particle reduction include, but are not limited to jet milling, hammer milling, compression milling and tumble milling processes (e.g., ball milling). Particle size control parameters for these processes are well understood by the person skilled in the art. For example the particle size reduction achieved in a jet milling process is controlled by adjusting a number of parameters, the primary ones being mill pressure and feed rate. In a hammer mill process, the particle size reduction is controlled by the feed rate, the hammer speed and the size of the opening in the grate/screen at the outlet. In a compression mill process, the particle size reduction is controlled by the feed rate and amount of compression imparted to the material (e.g. the amount of force applied to compression rollers).

The silicon based material can be subjected to milling in order to reduce the particle size of the silicon based material. This can be done prior to the formation of the first mixture or after the first mixture is formed. In the examples below, ball milling is used to reduce the size of the silicon based material and/or to reduce the number and/or size of agglomerates that may be present in the first mixture.

If desired, the solvent can optionally be removed from the first mixture after the step of milling the first mixture and prior to the step of adding the carbon based material using any method known in the art, such as for example, distillation with or without vacuum, fluid bed drying (FBD), spray drying, oven drying, vacuum drying, an/or other techniques known in the art. In certain embodiments, the solvent is removed from the first mixture after the step of milling by heating at 50-100° C.; 50-80° C.; or 60-80° C. optionally under vacuum.

The carbon material can be mixed with the first mixture in the presence of a solvent or neat. In instances where a solvent is used, any solvent can be used. Exemplary solvents include, water, alcohols, ethers, esters, ketones, hydrocarbons, aromatics, haloalkanes, and combinations thereof. In certain embodiments, the solvent is water, ethanol, isopropanol, or a combination thereof.

Carbon based material having a particle size of 10 to 30 μm is available commercially or can be prepared from carbon based material having a particle size larger than 30 μm. Any of the various known methods for controlling the particle size of substances, including reduction by comminution or de-agglomeration by milling (e.g., any of the aforementioned milling methods, including ball milling) and/or sieving can be used to prepare carbon based material of the desired particle size.

The carbon based material can be subjected to milling in order to reduce the particle size of the carbon based material. This can be done prior to the formation of the second mixture or after the second mixture is formed. Ball milling can be used to, e.g., reduce the size of the silicon based material, carbon based material, and/or to reduce the number and/or size of agglomerates that may be present in the second mixture.

If desired, the solvent can optionally be removed from the second mixture after the step of milling the second mixture and prior to the step of subjecting the second mixture to heat treatment using any method known in the art, such as for example, distillation with or without vacuum, fluid bed drying (FBD), spray drying, oven drying, vacuum drying, an/or other techniques known in the art. In certain embodiments, the solvent is removed from the second mixture after the step of milling the second mixture by heating at 50-100° C.; 50-80° C.; or 60-80° C. optionally under vacuum.

Heat treatment of the second mixture typically occurs under an inert atmosphere, such as nitrogen, argon, or a combination thereof, at temperature between 300-1,000° C., which causes the pyrolytic reaction of the dispersant thereby forming carbonaceous material. The carbonaceous material can comprise crystalline carbon (such as, for example, graphite), such as natural graphite and artificial graphite, amorphous carbon, such as soft carbon and hard carbon, and combinations thereof. In certain embodiments, the heat treatment comprises heating the second mixture at a temperature between 400-1,000° C.; 500-1,000° C.; 500-900° C.; 600-900° C.; 700-900° C. In certain embodiments, the heat treatment comprises heating the second mixture at the aforementioned temperatures for a period of time between 2 and 7 hours.

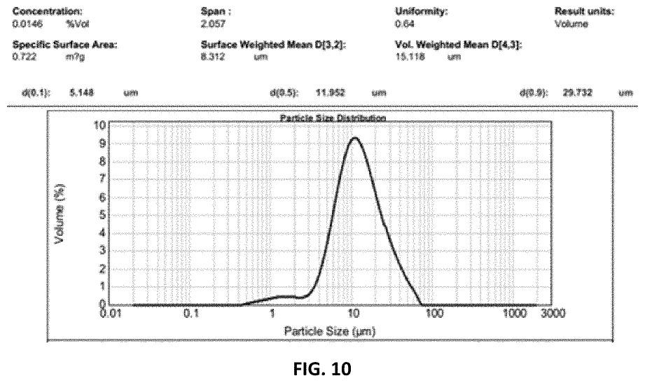

The anode active material disclosed herein can have an average particle size of 10-32 μm. In certain embodiments, the average particle size is 10 to 30; 10 to 28; 10 to 26; 10 to 24; 10 to 22; 10 to 20; 10 to 18; 10 to 16; 12 to 16; 14 to 16; or 14.5 to 15.5 μm. In certain embodiments, the carbon based material has a D50 particle size of 10 to 16; 10 to 14; 11 to 14; 11 to 13; 11.5 to 12.5 μm. FIG. 10 depicts the particle size distribution of exemplary anode active material.

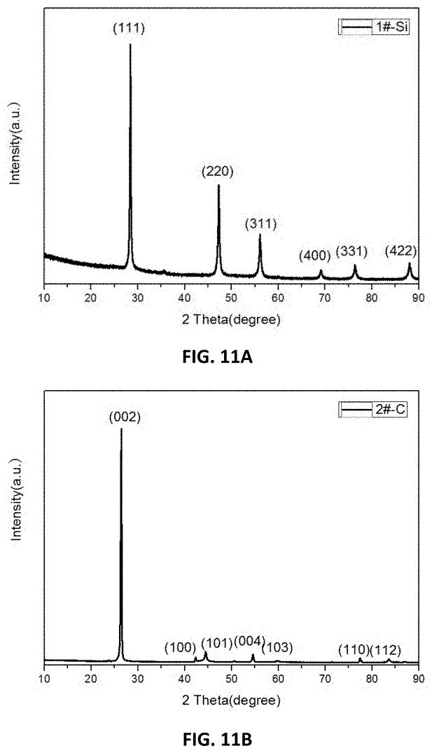

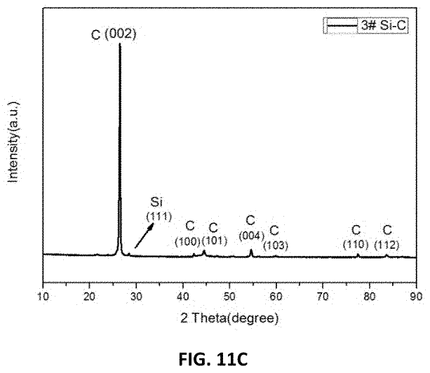

The XRD of exemplary silicon particles, graphite particles, and anode active material comprising the silicon particles, graphite particles, and carbonaceous material is depicted in FIG. 11A-11C, respectively. It can be observed that the XRD spectra of each of the silicon and graphite particles are substantially unchanged in the anode active material suggesting no change in the structure of each of the components in the anode active material.

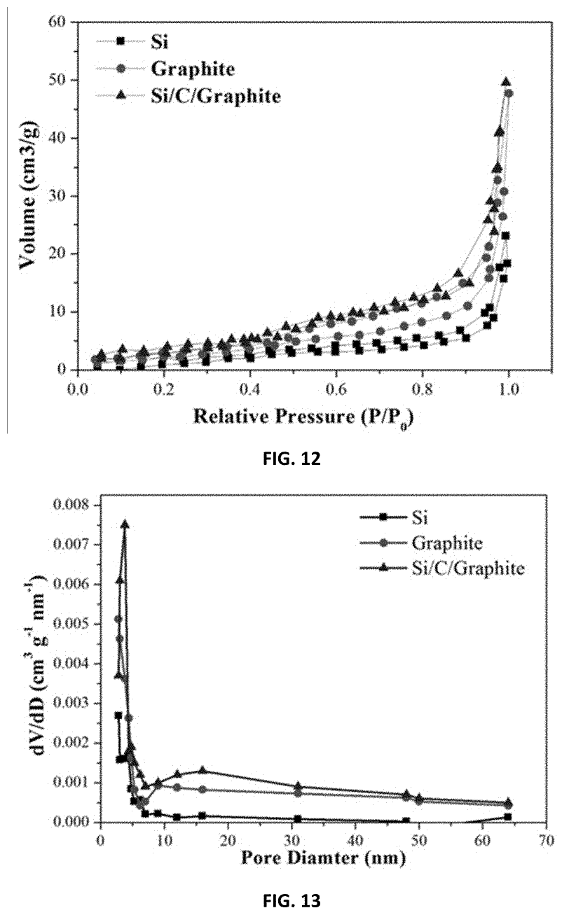

The electrochemical performance of the anode active material can be enhanced by increasing the Brunauer-Emmett-Teller (BET) surface area of the anode active material. FIG. 12 depicts the plot of volume vs relative pressure for silicon particles, graphite and anode active material comprising silicon particles, graphite, and a dispersant. In certain embodiments, the BET surface area of the anode active material is 2.9 to 3.3 m²/g; 3.0 to 3.2 m²/g; or 3.05 to 3.15 m²/g. In certain embodiments, the BET surface area of the anode active material is 3.1 m²/g. In certain embodiments, the BET surface area of the silicon nanoparticles are 35-40 m²/g; 36-40 m²/g; or 37-38 m²/g. In certain embodiments, the BET surface area of the silicon nanoparticles is 37.5 m²/g. In certain embodiments, the BET surface area of the graphite particles is 0.5-1 m²/g; 0.6-0.8 m²/g; or 0.65-0.75 m²/g. In certain embodiments, the BET surface area of the graphite particles is 0.7 m²/g.

The structure of the anode active materials can be highly heterogeneous comprising pores of a broad range of average size. FIG. 13 depicts the pore size distribution curves for certain embodiments of the ball milled silicon particles, graphite and anode active material comprising silicon particles, graphite, and a dispersant as described herein. FIG. 13 indicates that the anode active material as described herein can have uniformly distributed nanopores. In certain embodiments, the anode active materials comprise pores in the range of 3.5 to 500 nm.

Table 1 lists the features of exemplary anode active materials as described herein (Sample Nos. 1 and 6-12) and four comparative anode active materials (Sample Nos. 2-5).

TABLE 1

| Sample | Silicon | | | |
|---|---|---|---|---|
| No. | source | Dispersant | Graphite | Temperature |
| 1# | Nano-size Si | PVP | Yes | 800° C. |
| 2# | Micro-size Si | PVP | Yes | 800° C. |
| 3# | Nano-size Si | No | Yes | 800° C. |
| 4# | Nano-size Si | No | No | NA |
| 5# | Nano-size Si | PVP | No | 800° C. |
| 6# | Nano-size Si | CMC | Yes | 800° C. |
| 7# | Nano-size Si | glucose | Yes | 800° C. |
| 8# | Nano-size Si | PVP and | Yes | 800° C. |
| | | CMC | | |
| 9# | Nano-size Si | CMC and | Yes | 800° C. |
| | | glucose | | |
| 10# | Nano-size Si | PVP and | Yes | 800° C. |
| | | glucose | | |
| 11# | Nano-size | glucose | Yes | 800° C. |
| | SiO | | | |
| 12# | Nano-size | glucose | Yes | 800° C. |
| | SiO_{0.8} | | | |

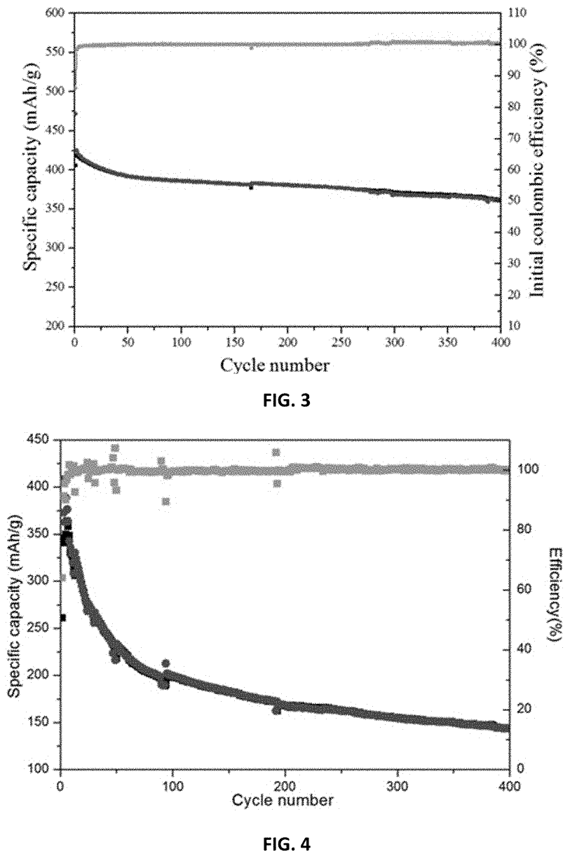

The electrochemical performance of the anode active materials listed in Table 1 are depicted in FIGS. 3-7 and 14-20 and tabulated Table 2 below.

Table 2 presents the electrochemical properties of the anode active materials as described herein (Sample Nos. 1 and 6-12) and four comparative anode active materials (Sample Nos. 2-5).

TABLE 2

| | Specific capacity | | |
|---|---|---|---|
| Samples | (mAh/g) | ICE (%) | Cycle retention |
| 1# | 425 | 86.5 | 400 cycles, 85% |
| 2# | 408 | 65.1 | 400 cycles, 35% |
| 3# | 423 | 76.2 | 380 cycles, 44% |
| 4# | 1920.8 | 54.5 | 400 cycles, 6.5% |
| 5# | 1509.7 | 82.3 | 400 cycles, 8.9% |
| 6# | 406.7 | 86.6 | 277 cycles, |
| | | | 92.5% |
| 7# | 450.3 | 93.4 | 400 cycles, 90% |
| 8# | 413.4 | 86.1 | 400 cycles, |
| | | | 88.8% |
| 9# | 421 | 87.5 | 400 cycles, |
| | | | 87.9% |
| 10 | 453 | 86.5 | 400 cycles, |
| | | | 88.5% |
| 11# | 429.8 | 82.6 | 400 cycles, |
| | | | 93.2% |
| 12# | 420 | 84.0 | 200 cycles, |
| | | | 99.3% |

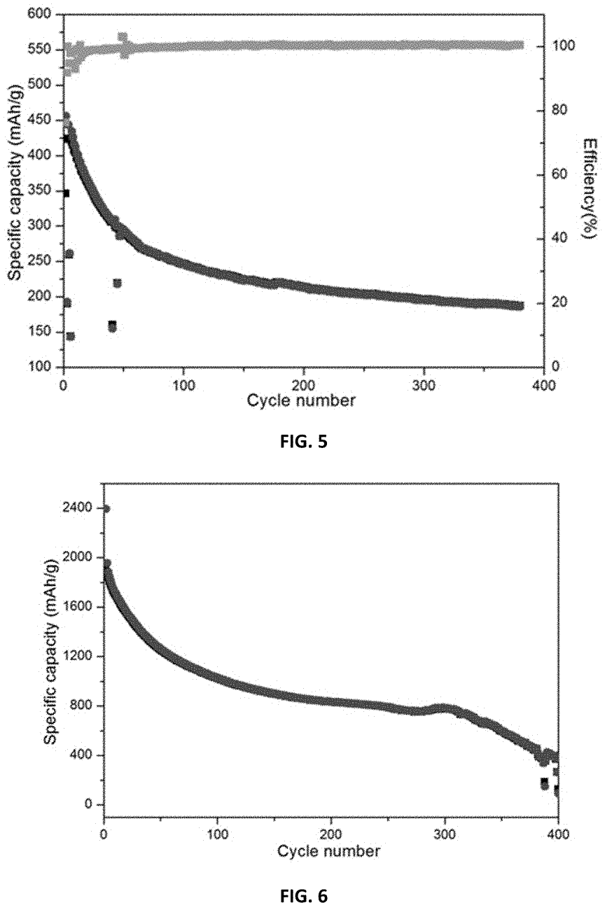

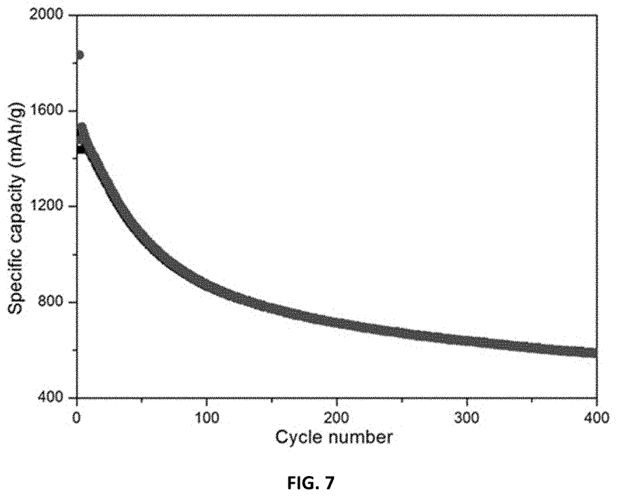

As can clearly be seen when comparing FIG. 3 and FIG. 4 (Sample No. 1 and 2), when larger sized silicon particles are used, the capacity retention of the anode active material decreases substantially. When no dispersant is used in the preparation of the anode active material and thus no carbonaceous material is formed during heat treatment, there is also a substantial decrease in capacity retention (comparing Samples No. 1 and 3 and FIG. 3 and FIG. 5). Anode active materials having no dispersant and no graphite exhibit a very high initial specific capacity, however the capacity retention decreases rapidly during repeated charge cycles (Sample No. 4 and FIG. 6). When the anode active material only contains silicon particles and carbonaceous material formed from the heat treatment of the dispersant in the second mixture, there is again a high initial specific capacity, which decreases rapidly as the result of multiple charge cycles (Sample No. 5 and FIG. 7). Anode active materials prepared using glucose alone as the dispersant or in combination with a second dispersant (such as PVP or CMC) exhibit higher capacity retention. Anode materials prepared using PVP alone as the dispersant or in combination with a second dispersant (such as glucose or CMC) also exhibit good capacity retention.

The anode active materials provided herein exhibit remarkable capacity retention upon repeated cycles with initial columbic efficiencies ranging from 83-93%. In certain embodiments, the anode active materials provided herein can have a capacity retention after 400 charge/discharge cycles up to 95%. In certain embodiments, the anode active materials provided herein can have a capacity retention after 400 charge/discharge cycles between 70% and 95%; 75% and 95%; 80% and 95%; 85% and 95%; and 88% and 93%.

### EXAMPLES

### Example 1

### Preparation of SiOₓ

Natural diatomite with an average size of 15 μm was calcined at 800° C. for 2 hr in air to remove the organic matter and then added to 6 M H₂SO₄ at 70° C. to remove any impurities, such as Fe₂O₃, Al₂O₃, MgO, and CaO. The diatomite was then collected by filtration, washed with multiple portions of water, and then dried. The diatomite was then mixed with Mg powder at a mass ratio of 1:0.8-1:1.5, calcined at 650-750° C. under an inert atmosphere such as Ar or N₂ for 6 hr. SiOₓ was obtained by removing the residual Mg, MgO and Mg₂Si with 0.1 M HCl solution. The resultant SiOₓ, wherein x is 0.8 average particles size was about 0.5-1.0 μm.

### Example 2

### Preparation of SiOₓ/C/Graphite Anode Active Material

To prepare the SiOₓ/glucose/graphite anode active material, 1 g SiOₓ (prepared in Example 1) was first mixed with glucose in a mass ratio of 1:1-1:5 in ethanol by ball milling at 550 rpm for 4 hr. After that, 25 g graphite with size of 10-30 μm was added to the above SiOₓ/glucose solution and ball milling was continued for another 2 hr at 300 rpm. The SiOₓ/glucose/graphite mixture was dried at 60° C. in vacuum for 12 hr. The as obtained dry SiOₓ/glucose/graphite mixture was sintered at 700-900° C. under inert N₂ for 2-6 hr with a heating rate of 5° C./min to obtain the SiOₓ/C/graphite anode active material.

### Example 3

### Preparation of Si/C/G Anode Active Material

1 g Si particles with size of 50 μm was mixed with the carbon source with weight ratio of 1:7-3:7 in 40 ml water or 40 ml mixture of ethyl alcohol and water with volume ratio of 1:1 to 3:1, the carbon source contains one or more kind of the following chemical, such as glucose, source, PVP, CMC, resin and so on. Then the above Si/carbon source mixture was ball milled at 550 rpm for 4 hr. Then, 20 g graphite with size of 10-30 μm was added to the above mixture, followed by ball milling for another 2 hr at 300 rpm to form a homogeneous Si/carbon/graphite suspension solution. The homogeneous suspension solution was dried by spray drying or in vacuum oven at 80° C. for 12 hr. The resulting dry Si/carbon/graphite powder was calcined at 700-1000° C. for 2-6hr with a heating rate of 5° C./min in Ar or N₂ atmosphere.

Preparation of SiO/C/G Anode Active Material

1 g industrial grade SiO particles with size of 300 mesh was mixture with the carbon source with weight ratio of 1:7-3:7 in 40 ml water or 40 ml mixture of ethyl alcohol and water with volume ratio of 1:1 to 3:1, the carbon source contains one or more kind of the following chemical, such as glucose, source, PVP, CMC, resin and so on. Then the above SiO/carbon source mixture was ball milled at 550 rpm for 4 hr. After that, 20 g graphite with size of 10-30 μm was added to the above mixture, followed by ball milling for another 2 hr at 300 rpm to form a homogeneous SiO/carbon/graphite suspension solution. The homogeneous suspension solution was dried by spray drying or in vacuum oven at 80° C. for 12 hr. The resulting dry Si/carbon/graphite powder was calcined at 700-900° C. for 2-6 hr with a heating rate of 5° C./min in Ar or N₂ atmosphere.

Preparation of Sample No. 1

1 g Si particles with size of 50 μm was mixture with 7 g polyvinylpyrrolidone (PVP) in 40 ml water. Then the above Si/PVP mixture was ball milled at 550 rpm for 4 hr. Then, 20 g graphite particles with size of 10-30 μm was added to the above mixture, followed by ball milling for another 2 hr at 300 rpm to form a homogeneous Si/PVP/graphite suspension solution. The homogeneous suspension solution was dried in vacuum oven at 80° C. for 12 hr. The resulting dry Si/PVP/graphite powder was calcined at 800° C. for 4 hr with a heating rate of 5° C./min in Ar atmosphere form Si/C/Graphite anode materials. The results of the electrochemical testing of Sample No. 1 is shown in FIG. 3.

Preparation of Sample No. 2

1 g Si particles with size of 50 μm was mixture with the 7 g PVP and 20 g graphite particles in 40 ml water. Then the above Si/PVP/graphite mixture was ball milled at 300 rpm for 2 hr form a homogeneous Si/PVP/graphite suspension solution. The homogeneous suspension solution was dried in vacuum oven at 80° C. for 12 hr. The resulting dry Si/PVP/graphite powder was calcined at 800° C. for 4 hr with a heating rate of 5° C./min in Ar atmosphere form Si/C/Graphite anode materials. The results of the electrochemical testing of Sample No. 2 is shown in FIG. 4.

Preparation of Sample No. 3

1 g Si particles with size of 50 μm was added in 40 ml water. Then the above Si suspension solution was ball milled at 550 rpm for 4 hr. Then, 20 g graphite particles with size of 10-30 μm was added to the above Si suspension solution, followed by ball milling for another 2 hr at 300 rpm to form a homogeneous Si/graphite suspension solution. The homogeneous suspension solution was dried in vacuum oven at 80° C. for 12 hr. The resulting dry Si/graphite powder was calcined at 800° C. for 4 hr with a heating rate of 5° C./min in Ar atmosphere form Si/Graphite anode material. The results of the electrochemical testing of Sample No. 3 is shown in FIG. 5.

Preparation of Sample No. 4

1 g Si particles with size of 50 μm was added in 40 ml water. Then the Si suspension solution was ball milled at 550 rpm for 4 hr to form Nano-size Si particles. Then, the homogeneous suspension Si water solution was dried in vacuum oven at 80° C. for 12 hr. The dried Si powder was used as anode active material directly without any other treatment. The results of the electrochemical testing of Sample No. 4 is shown in FIG. 6.

Preparation of Sample No. 5

1 g Si particles with size of 50 μm was mixture with 7 g polyvinylpyrrolidone (PVP) in 40 ml water. Then the above Si/PVP mixture was ball milled at 550 rpm for 4 hr. The homogeneous suspension solution was dried in vacuum oven at 80° C. for 12 hr. The resulting dry Si/PVP powder was calcined at 800° C. for 4 hr with a heating rate of 5° C./min in Ar atmosphere form Si/C anode materials. The results of the electrochemical testing of Sample No. 5 is shown in FIG. 7.

Preparation of Sample No. 6

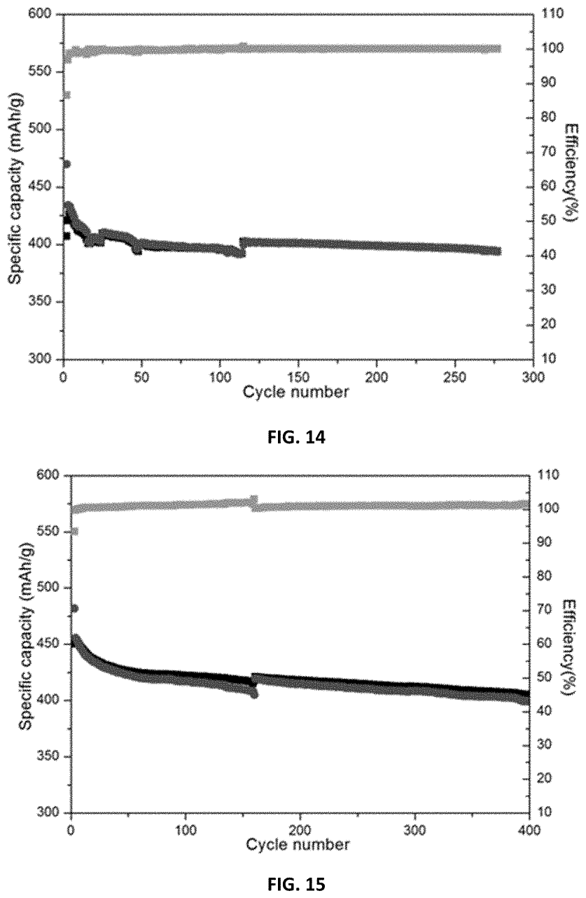

1 g Si particles with size of 50 μm was mixture with 7 g carboxymethyl cellulose sodium (CMC) in 40 ml water. Then the above Si/PVP mixture was ball milled at 550 rpm for 4 hr. Then, 20 g graphite particles with size of 10-30 μm was added to the above mixture, followed by ball milling for another 2 hr at 300 rpm to form a homogeneous Si/CMC/graphite suspension solution. The homogeneous suspension solution was dried in vacuum oven at 80° C. for 12 hr. The resulting dry Si/CMC/graphite powder was calcined at 800° C. for 4 hr with a heating rate of 5° C./min in Ar atmosphere form Si/C/Graphite anode materials. The results of the electrochemical testing of Sample No. 6 is shown in FIG. 14.

Preparation of Sample No. 7

1 g Si particles with size of 50 μm was mixture with 7 g glucose in 40 ml water. Then the above Si/glucose mixture was ball milled at 550 rpm for 4 hr. Then, 20 g graphite particles with size of 10-30 μm was added to the above mixture, followed by ball milling for another 2 hr at 300 rpm to form a homogeneous Si/glucose/graphite suspension solution. The homogeneous suspension solution was dried in vacuum oven at 80° C. for 12 hr. The resulting dry Si/PVP/graphite powder was calcined at 800° C. for 4 hr with a heating rate of 5° C./min in Ar atmosphere form Si/C/Graphite anode materials. The results of the electrochemical testing of Sample No. 7 is shown in FIG. 15.

Preparation of Sample No. 8

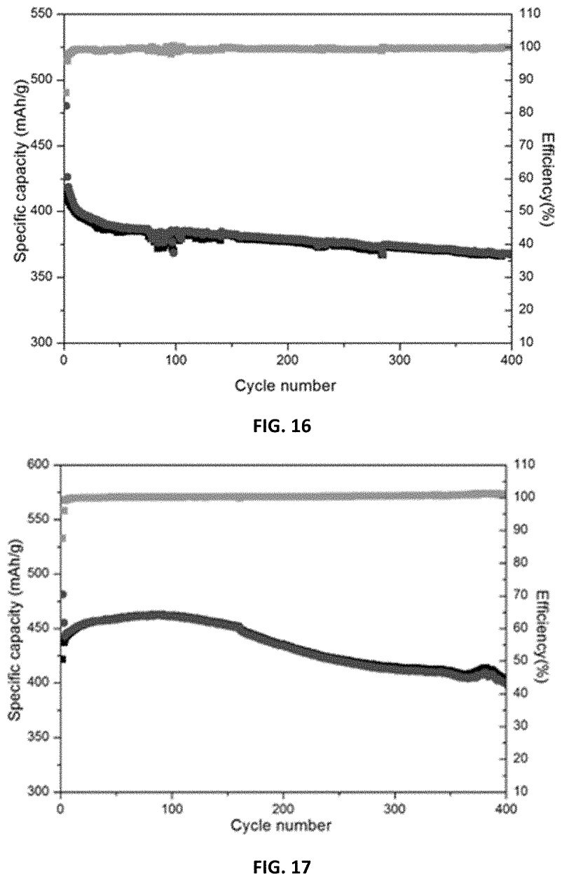

1 g Si particles with size of 50 μm was mixture with 3.5 g polyvinylpyrrolidone (PVP) and 3.5 g carboxymethyl cellulose sodium (CMC) in 40 ml water. Then the above Si/PVP-CMC mixture was ball milled at 550 rpm for 4 hr. Then, 20 g graphite particles with size of 10-30 μm was added to the above mixture, followed by ball milling for another 2 hr at 300 rpm to form a homogeneous Si/PVP-CMC/graphite suspension solution. The homogeneous suspension solution was dried in vacuum oven at 80° C. for 12 hr. The resulting dry Si/PVP-CMC /graphite powder was calcined at 800° C. for 4 hr with a heating rate of 5° C./min in Ar atmosphere form Si/C/Graphite anode materials. The results of the electrochemical testing of Sample No. 8 is shown in FIG. 16.

Preparation of Sample No. 9

1 g Si particles with size of 50 μm was mixture with 3.5 g glucose and 3.5 g carboxymethyl cellulose sodium (CMC) in 40 ml water. Then the above Si/CMC-glucose mixture was ball milled at 550 rpm for 4 hr. Then, 20 g graphite particles with size of 10-30 μm was added to the above mixture, followed by ball milling for another 2 hr at 300 rpm to form a homogeneous Si/CMC-glucose/graphite suspension solution. The homogeneous suspension solution was dried in vacuum oven at 80° C. for 12 hr. The resulting dry Si/PVP/graphite powder was calcined at 800° C. for 4 hr with a heating rate of 5° C./min in Ar atmosphere form Si/C/Graphite anode materials. The results of the electrochemical testing of Sample No. 9 is shown in FIG. 17.

Preparation of Sample No. 10

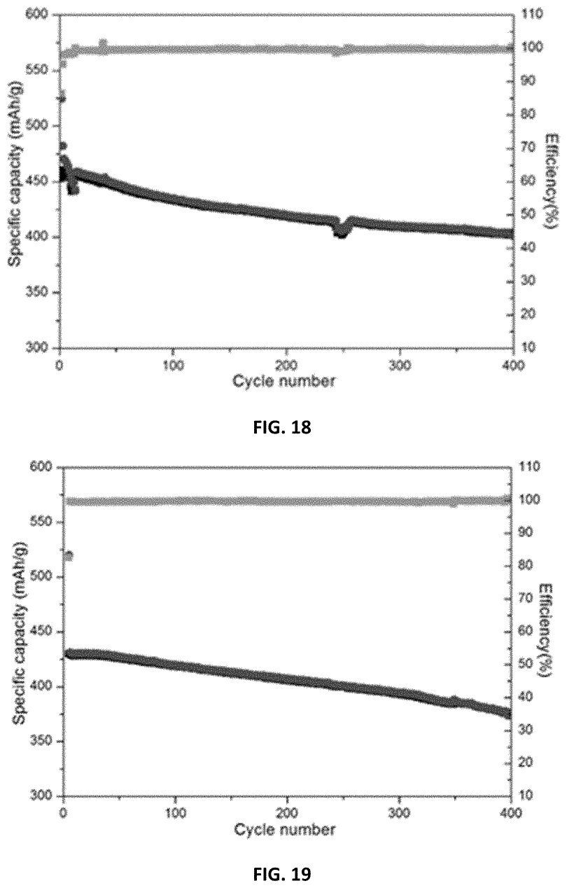

1 g Si particles with size of 50 μm was mixture with 3.5 g polyvinylpyrrolidone (PVP) and 3.5 g glucose in 40 ml water. Then the above Si/PVP-glucose mixture was ball milled at 550 rpm for 4 hr. Then, 20 g graphite particles with size of 10-30 μm was added to the above mixture, followed by ball milling for another 2 hr at 300 rpm to form a homogeneous Si/PVP-glucose/graphite suspension solution. The homogeneous suspension solution was dried in vacuum oven at 80° C. for 12 hr. The resulting dry Si/PVP-glucose/graphite powder was calcined at 800° C. for 4 hr with a heating rate of 5° C./min in Ar atmosphere form Si/C/Graphite anode materials. The results of the electrochemical testing of Sample No. 10 is shown in FIG. 18.

Preparation of Sample No. 11

1 g SiO particles with size of 50 μm was mixture with 7 g glucose in 40 ml water. Then the above Si/glucose mixture was ball milled at 550 rpm for 4 hr. Then, 20 g graphite particles with size of 10-30 μm was added to the above mixture, followed by ball milling for another 2 hr at 300 rpm to form a homogeneous Si/glucose /graphite suspension solution. The homogeneous suspension solution was dried in vacuum oven at 80° C. for 12 hr. The resulting dry Si/glucose /graphite powders was calcined at 800° C. for 4 hr with a heating rate of 5° C./min in Ar atmosphere form Si/C/Graphite anode materials. The results of the electrochemical testing of Sample No. 11 is shown in FIG. 19.

Preparation of Sample No. 12

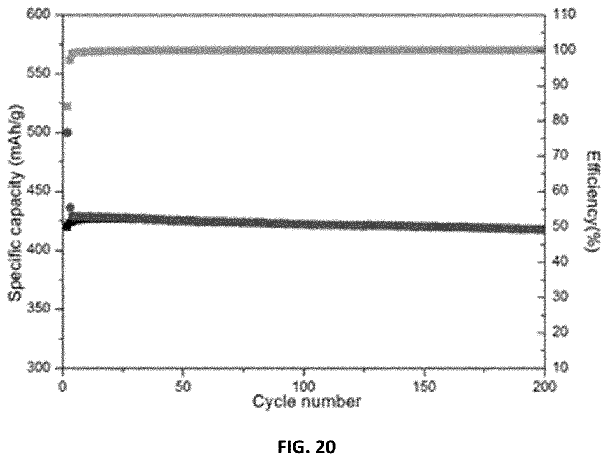

1 g SiO_{0.8} particles with size of 0.5-1 μm was mixture with 7 g glucose in 40 ml water. Then the above Si/glucose mixture was ball milled at 550 rpm for 4 hr. Then, 20 g graphite particles with size of 10-30 μm was added to the above mixture, followed by ball milling for another 2 hr at 300 rpm to form a homogeneous Si/glucose/graphite suspension solution. The homogeneous suspension solution was dried in vacuum oven at 80° C. for 12 hr. The resulting dry Si/glucose/graphite powder was calcined at 800° C. for 4 hr with a heating rate of 5° C./min in Ar atmosphere form Si/C/Graphite anode materials. The results of the electrochemical testing of Sample No. 12 is shown in FIG. 20.

Preparation of Electrochemical Cells

Electrochemical performance of the Si/C/Graphite samples was evaluated by galvanostatic cycling using CR2025-type coin cells. The electrode slurry was made by dispersing 90 wt % Si/C/Graphite, 4 wt % acetylene black and 6 wt % carboxymethyl cellulose sodium (CMC) in deionized water with stirring for 2 hr. Then, the slurry was coated uniformly on Cu foil and dried overnight at 80° C. under vacuum to yield the working electrodes. The active material loading was about 4.0 mg/cm². The electrodes were then assembled into half cells in an Ar-filled glove box using Li foil as the counter electrodes and Celgard 2300 membrane as the separators. The electrolyte used was 1 M LiPF₆ in ethylene carbonate (EC)/dimethyl carbonate (DMC) (1:1 in volume) with 5 vol % fluoroethylene carbonate (FEC).

Electrochemical Testing In the charge and discharge measurements, the voltage range was 0.005-1.2 V versus Li⁺/Li. In the first cycle, the batteries were charged from 0.005 to 1.2 V under a constant current of 0.05 C, where 1 C equals to 450 mA g⁻¹. The batteries were then discharged from 1.2 to 0.005 V with the same constant current. In the subsequent cycles, the batteries were cycled at the constant current of 0.5 C.

What we claim:

1. A method for preparing an anode active material comprising the steps of:
a) contacting a silicon based material with a dispersant thereby forming a first mixture comprising the silicon based material and the dispersant;
b) contacting the first mixture with a carbon based material thereby forming a second mixture comprising the silicon based material, the carbon based material, and the dispersant; and
c) subjecting the second mixture to heat treatment thereby forming the anode active material,
wherein the particle size of the silicon based material is 100 to 300 nm and the particle size of the carbon based material is 10 to 30 μm.

2. The method of claim 1, wherein the silicon based material is selected from the group consisting of silicon particles, SiOₓ particles, SiO particles, and combinations thereof, wherein x is 0.1 to 1.9.

3. The method of claim 1, wherein the carbon based material is selected from the group consisting of graphite particles, carbon black particles, and combinations thereof.

4. The method of claim 1, wherein the dispersant is at least one compound selected from the group consisting of glucose, fructose, sucrose, cellulose, starch, citric acid, carboxymethyl cellulose, polyacrylic acid, polymethylacrylate, polyether imide, polyvinyl pyrrolidone, epoxy resin, phenolic resin and pitch.

5. The method of claim 1, wherein the mass ratio of the silicon based material to the dispersant to the carbon based material in the second mixture is 0.5:7:20 to 3:7:20.

6. The method of claim 1 further comprising the steps of ball milling the first mixture prior to the step of contacting the first mixture with the carbon based material; and ball milling the second mixture prior to the step of subjecting the second mixture to heat treatment.

7. The method of claim 6 further comprising the step drying the second mixture after the step of ball milling the second mixture and before the step of subjecting the second mixture to heat treatment.

8. The method of claim 1, wherein the step of heat treatment comprises heating the second mixture at a temperature of 300 to 1,000° C. under an inert atmosphere.

9. The method of claim 6, wherein the particle size of the anode active material is 8 to 25 μm.

10. A method for preparing an anode active material comprising the steps of:
a. contacting silicon particles having a particle size of 10-30 μm, with glucose thereby forming a first mixture comprising the silicon particles and glucose having a mass ratio of 0.5:7 to 3:7;
b. ball milling the first mixture thereby forming a milled first mixture comprising silicon particles having a D50 of 150 to 190 nm;
c. contacting the first mixture with graphite particles having a D50 of 15 to 16 μm thereby forming a second mixture comprising the silicon particles, the graphite particles, and glucose having a mass ratio of the silicon particles to the graphite particles to glucose of 0.5:20:7 to 3:20:7;
d. ball milling the second mixture thereby forming a milled second mixture;
e. drying the milled second mixture thereby forming a dried second mixture; and
f. subjecting the dried second mixture to heat treatment at 700 to 900° C. under an inert atmosphere thereby forming the anode active material,
wherein the D50 of the anode active material is 11.5 to 12.5 μm and the anode active material has a Brunauer-Emmett-Teller (BET) surface area of 3.05-3.15 m²/g.

11. An anode active material prepared according to the method of claim 1.

12. An anode active material prepared according to the method of claim 10.

13. An anode comprising the anode active material of claim 11.

14. An anode comprising the anode active material of claim 12.

15. A lithium-ion battery comprising the anode of claim 13.

16. A lithium-ion battery comprising the anode of claim 14.

17. The lithium-ion battery of claim 15, wherein the anode active material has a specific capacity between 400 to 500 mAh/g.

18. The lithium-ion battery of claim 15, wherein the anode active material has a capacity retention of between 75% and 95% after 400 cycles.

19. The lithium-ion battery of claim 16, wherein the anode active material has a specific capacity between 400 to 450 mAh/g.

20. The lithium-ion battery of claim 16, wherein the anode active material has a capacity retention of between 85% and 90% after 400 cycles.
